(19) United States
(12) Patent Application Publication
(10) Pub. No.: US 2025/0303878 A1
(43) Pub. Date: Oct. 2, 2025

(54) SOLAR CHARGING SYSTEM

(71) Applicant: TOYOTA JIDOSHA KABUSHIKI KAISHA, Toyota-shi (JP)

(72) Inventor: Yukinori MURAKAMI, Toyota-shi (JP)

(73) Assignee: TOYOTA JIDOSHA KABUSHIKI KAISHA, Toyota-shi (JP)

(21) Appl. No.: 19/012,910

(22) Filed: Jan. 8, 2025

(30) Foreign Application Priority Data
Mar. 27, 2024 (JP) 2024-051391

(51) Int. Cl. B60L 8/00; B60L 53/51

(52) U.S. Cl. CPC B60L 8/003; B60L 53/51

(57) ABSTRACT

A solar charging system using a plurality of solar panels, the plurality of solar panels comprising: a first solar panel; a second solar panel having an output for a predetermined amount of solar radiation higher than that of the first solar panel; a first power converter for converting the generated power of the first solar panel with a first efficiency; and a second power converter for converting the generated power of the second solar panel with a second efficiency higher than the first efficiency.

### CROSS-REFERENCE TO RELATED APPLICATION

This application claims priority to Japanese Patent Application No. 2024-051391 filed on Mar. 27, 2024, incorporated herein by reference in its entirety.

### BACKGROUND

### 1. Technical Field

The present disclosure relates to a solar charging system using a plurality of solar panels.

### 2. Description of Related Art

Japanese Unexamined Patent Application Publication No. 2020-141545 (JP 2020-141545 A) discloses a solar charging system using a plurality of solar panels mounted on a vehicle. The solar charging system acquires a power generation amount of each of the solar panels and a power amount required by a power supply destination, and appropriately controls driving of a plurality of power converters provided in association with the solar panels based on the acquisition results.

### SUMMARY

When installing a plurality of solar panels in a limited space, the solar panels are stacked and installed on a flat surface even if conditions (angle, area, etc.) are slightly poor. In the solar panels installed in this manner, however, the power generation amounts, the heat generation amounts, etc. are different. For this reason, when power converters having the same performance and configuration are used for power control on the solar panels, there is a possibility that processing efficiency for power generation of each solar panel and heat dissipation performance for heat generation are not optimized and inequality (unevenness) may occur.

The present disclosure provides a solar charging system capable of optimizing processing efficiency for power generation and heat dissipation performance for heat generation in a configuration using a plurality of solar panels.

One aspect of the disclosed technology is

a solar charging system using a plurality of solar panels.
The solar panels include a first solar panel and a second solar panel in which output for a predetermined amount of solar radiation is higher than output from the first solar panel. The solar charging system includes a first power converter configured to convert electric power generated by the first solar panel with a first efficiency, and a second power converter configured to convert electric power generated by the second solar panel with a second efficiency higher than the first efficiency.

In the solar charging system of the present disclosure, the solar panels are assigned the power converters having efficiencies associated with output capabilities of the solar panels. As a result, it is possible to optimize the processing efficiency for power generation and the heat dissipation performance for heat generation.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram showing a configuration example of a solar charging system according to the present embodiment;

FIG. 2 is a diagram showing an embodiment in which a plurality of solar panels are mounted on vehicles in a multi-system configuration; and

FIG. 3 is a diagram illustrating an example in which a plurality of solar panels are mounted on a vehicle in a multi-junction structure.

### DETAILED DESCRIPTION OF EMBODIMENTS

The solar charging system of the present disclosure allocates, to a plurality of solar panels, power converters each having an efficiency (loss, calorific value, and the like) corresponding to the output capacity of each solar panel. Therefore, it is possible to optimize the processing efficiency for the power generation of the solar panel and the heat dissipation performance for the heat generation.

Hereinafter, an embodiment of the present disclosure will be described in detail with reference to the drawings.

### Embodiment

### Configuration

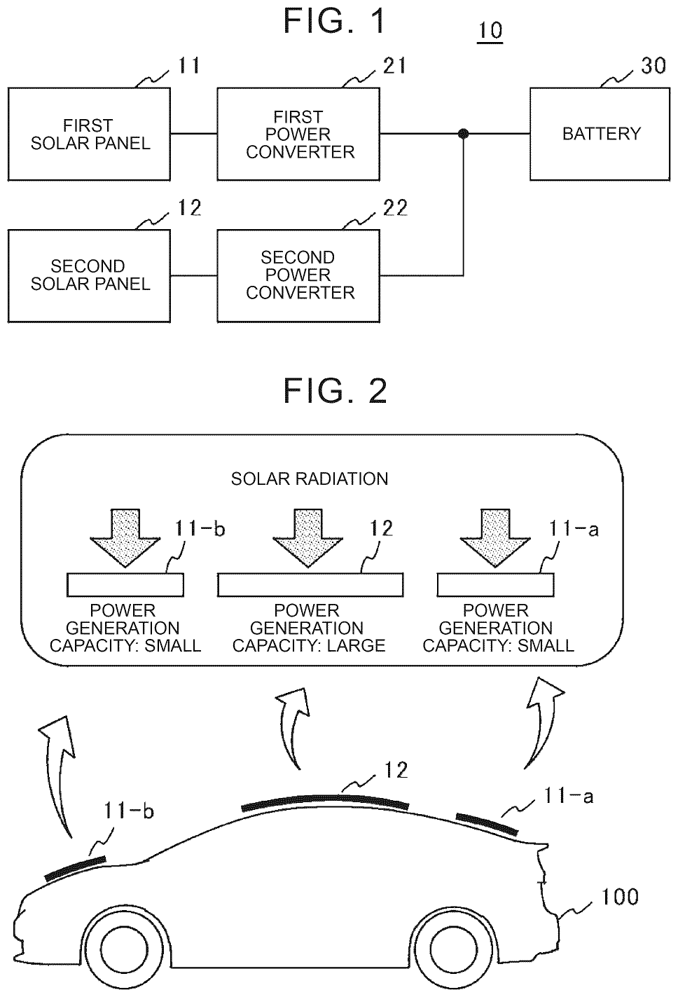

FIG. 1 is a block diagram illustrating a schematic configuration of a solar charging system 10 according to an embodiment of the present disclosure. The solar charging system 10 illustrated in FIG. 1 includes a first solar panel 11, a second solar panel 12, a first power converter 21, a second power converter 22, and a battery 30.

The solar charging system 10 may be mounted on vehicles such as hybrid electric vehicle (HEV), plug-in hybrid electric vehicle (PHEV), and battery electric vehicle (BEV), for example.

Each of the first solar panel 11 and the second solar panel 12 is a device capable of generating electric power corresponding to the irradiation amount of sunlight, and is typically an aggregate of solar cells. FIG. 1 shows an example in which the first solar panel 11 and the second solar panel 12 are each one, but the number of the respective panels is not limited thereto.

The first solar panel 11 and the second solar panel 12 have different power generation capabilities. In the present embodiment, the power generation capability of the second solar panel 12 is relatively higher than the power generation capability of the first solar panel 11.

In the case where the first solar panel 11 and the second solar panel 12 are arranged at different locations in a planar manner, for example, a solar panel having a large panel area or a solar panel in which a surface subjected to solar radiation is often perpendicular to the solar direction may be the second solar panel 12 having a relatively large power generation capability. Other solar panels may be the first solar panel 11 with relatively low power generation capability. It should be noted that whether the installed solar panel corresponds to the first or the second solar panel may be determined based on a predetermined criterion (threshold value or the like).

FIG. 2 shows an example of an image when the first solar panel 11 and the second solar panel 12 are installed in a planar manner on the vehicle 100 (multi-system structure). In the example of FIG. 2, the solar panel having a large panel area installed on the roof of the vehicle 100 is the second solar panel 12 because of its large power generation capability. In addition, the solar panel having a small panel area installed in the back door of the vehicle 100 and the front hood of the vehicle 100 is the first solar panel 11-a and the first solar panel 11-b because the power generation capacity is small.

In the case where the first solar panel 11 and the second solar panel 12 are placed three-dimensionally on the same place, for example, a solar panel (hereinafter referred to as a “top layer panel”) disposed on the top surface that can directly receive solar radiation from the sun to increase the amount of power generation may be the second solar panel 12 having a relatively large power generation ratio with respect to solar radiation. Other solar panels that indirectly receive solar radiation from the sun through the top layer panel (hereinafter referred to as “bottom layer panels”) may be the first solar panel 11 having a relatively small power generation ratio to solar radiation.

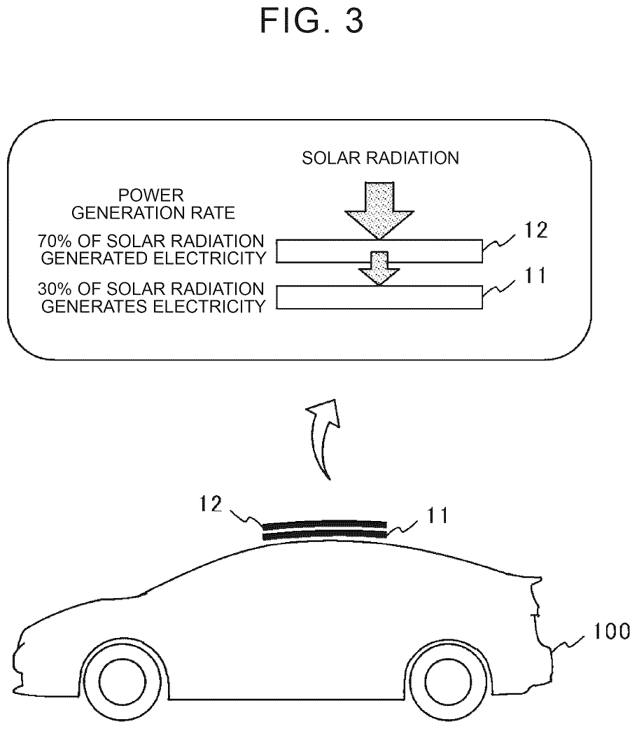

FIG. 3 shows an example of an image obtained when the first solar panel 11 and the second solar panel 12 are three-dimensionally installed in the vehicle 100 (multi-junction structure). In the example of FIG. 3, among the plurality of layer panels installed on the roof of the vehicle 100, the uppermost layer panel is adjusted in a ratio so as to generate electric power at 70% of the solar radiation, thereby forming the second solar panel 12. Further, among the plurality of layer panels installed on the roof of the vehicle 100, the lower layer panel indirectly receiving the solar radiation from the sun through the top layer panel is adjusted so as to generate power at 30% of the solar radiation to form the first solar panel 11.

The first power converter 21 and the second power converter 22 are provided corresponding to the first solar panel 11 and the second solar panel 12, respectively. The first power converter 21 and the second power converter 22 are configurations for independently controlling power generation of the first solar panel 11 and the second solar panel 12. In FIG. 1, an example in which the first power converter 21 and the second power converter 22 are each one is illustrated, but the present disclosure is not limited thereto, and a plurality of the first power converters and the second power converters are provided depending on the number of the first solar panels 11 and the second solar panels 12.

The first power converter 21 typically includes a DCDC converter that receives electric power generated by the first solar panel 11, converts the input electric power into a predetermined voltage, and outputs the voltage. The second power converter 22 typically includes a DCDC converter that receives electric power generated by the second solar panel 12, converts the input electric power into a predetermined voltage, and outputs the voltage.

The first power converter 21 and the second power converter 22 have different efficiency (loss, calorific value) for converting the generated electric power of the first solar panel 11 and the generated electric power of the second solar panel 12 into predetermined electric power, respectively. In the present embodiment, the efficiency (second efficiency) of the second power converter 22 is relatively higher than the efficiency (first efficiency) of the first power converter 21. This highly efficient second power converter 22 is connected to the second solar panel 12, which has a higher power generation capacity compared to the first solar panel 11. A standard efficiency first power converter 21 that is less efficient than the second power converter 22 is connected to the first solar panel 11. The outputs of the first power converter 21 and the second power converter 22 are supplied in parallel to the battery 30.

The battery 30 is a secondary battery configured to be chargeable and dischargeable, such as a lithium ion battery or a lead storage battery. The battery 30 is connected to the first power converter 21 and the second power converter 22. The battery 30 is configured to be able to charge the power generated by the first solar panel 11 via the first power converter 21, and to charge the power generated by the second solar panel 12 via the second power converter 22.

### EFFECTS

According to the solar charging system 10 according to the embodiment of the present disclosure described above, a high-efficiency power converter (second power converter 22) is allocated to a solar panel (second solar panel 12) having a large power generation capacity, a large power generation amount, or a high output with respect to the solar radiation amount. According to the solar charging system 10, a low-efficiency power converter (first power converter 21) is allocated to a solar panel (first solar panel 11) having a small power generation capacity, a small power generation amount, or a low output to the solar radiation amount. That is, a plurality of solar panels are each assigned a power converter having an efficiency corresponding to the output capability of each solar panel.

With this allocation method, it is possible to avoid that a large amount of power is processed by a power converter having a large loss and heat generation is increased, or that a power converter having a high efficiency is wastefully used in a panel having a small power generation amount. Therefore, it is possible to reduce the temperature unevenness and the deviation of the heat generation amount in the power conversion using the plurality of solar panels, and it is possible to reduce the load on the components. That is, according to the solar charging system 10 of the present embodiment, it is possible to optimize the processing efficiency for power generation of the solar panel and the heat dissipation performance for heat generation.

The solar charging system of the present disclosure can be used in a vehicle equipped with a plurality of solar panels.

What is claimed is:

1. A solar charging system using a plurality of solar panels, the solar panels including a first solar panel and a second solar panel in which output for a predetermined amount of solar radiation is higher than output from the first solar panel, the solar charging system comprising:
a first power converter configured to convert electric power generated by the first solar panel with a first efficiency; and
a second power converter configured to convert electric power generated by the second solar panel with a second efficiency higher than the first efficiency.

2. The solar charging system according to claim 1, wherein:
the solar panels are mounted on a vehicle;
the second solar panel is a panel installed on a roof of the vehicle; and
the first solar panel is a panel installed on at least either of a front hood and a back door of the vehicle.

3. The solar charging system according to claim 1, wherein:
the second solar panel is a panel installed on an uppermost layer of a multi-layer panel, and the multi-layer panel includes a stack of two or more solar panels; and
the first solar panel is a panel installed on a lower layer other than the uppermost layer of the multi-layer panel.
